(19) United States
(12) Patent Application Publication
(10) Pub. No.: US 2006/0044441 A1
(43) Pub. Date: Mar. 2, 2006

(54) Image sensor for still or video photography

(75) Inventor: Christopher Parks, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/009,567

(22) Filed: Dec. 10, 2004

Related U.S. Application Data
(60) Provisional application No. 60/605,034, filed on Aug. 27, 2004.

(51) Int. Cl. H04N 5/335

(52) U.S. Cl. 348/322

(57) ABSTRACT

A method for reading out charge from an interlined CCD having a plurality of photo-sensing regions and a plurality of vertical shift registers, and each photosensitive region is mated respectively to a CCD of a vertical shift register and a color filter having a repeating pattern of two rows in which each row includes at least two colors that forms a plurality of 3 line sub-arrays sequentially numbered in the space domain; and the color filter spanning the photo-sensing regions, the method includes reading out lines 1 and 3 into the vertical shift register that keeps the colors separated; summing the charge in lines 1 and 3; transferring one row of the summed charge into a first horizontal charge-coupled device; transferring alternate charges in the first horizontal charge-coupled device into a second horizontal charge-coupled device; summing sets of two charges in the first horizontal charge-coupled device; summing sets of two charges in the second horizontal charge-coupled device; and reading out the charge in both the first and second horizontal shift register with a half-resolution clocking sequence.

### CROSS-REFERENCE TO RELATED APPLICATIONS

This is a 111A application of Provisional Application Ser. No. 60/605,034, filed Aug. 27, 2004.

### FIELD OF THE INVENTION

The invention relates generally to the field of image sensors and, more particularly, to producing at least 30 frames per second (video) by sampling the entire array of the image sensor and summing pixel values in a predetermined manner to reduce the image size by a factor of 3.

### BACKGROUND OF THE INVENTION

Referring to FIG. 1, an interline charge coupled device (CCD) image sensor 10 is comprised of an array of photodiodes 20. The photodiodes are covered by color filters to allow only a narrow band of light wavelengths to generate charge in the photodiodes. Typically image sensors have a pattern of three or more different color filters arranged over the photodiodes in a 2×2 sub array as shown in FIG. 2. For the purpose of a generalized discussion, the 2×2 array is assumed to have four colors, A, B, C, and D. The most common color filter pattern used in digital cameras, often referred to as the Bayer pattern, color A is red, colors B and C are green, and color D is blue.

Referring back to FIG. 1, image readout of the photo-generated charge begins with the transfer of some or all of the photodiode charge to the vertical CCD (VCCD) 30. In the case of a progressive scan CCD, every photodiode simultaneously transfers charge to the VCCD 30. In the case of a two field interlaced CCD, first the even numbered photodiode rows transfer charge to the VCCD 30 for first field image readout, then the odd numbered photodiode rows transfer charge to the VCCD 30 for second field image readout.

Charge in the VCCD 30 is read out by transferring all columns in parallel one row at a time into the horizontal CCD (HCCD) 40. The HCCD 40 then serially transfers charge to an output amplifier 50.

FIG. 1 shows an array of only 24 pixels. Many digital cameras for still photography employ image sensors having millions of pixels. An 8-megapixel image sensor would require at least ⅓ second to read out at a 40 MHz data rate. This is not suitable if the same camera is to be used for recording video. A video recorder typically requires an image read out in 1/30 second. The shortcoming to be addressed by the present invention is how to use an image sensor with more than 1 million pixels as both a high quality digital still camera and 30 frames/second video camera. In particular the invention describes how to reduce the resolution of an image sensor by a factor of 3 by summing together pixels of the same color.

The prior art addresses this problem by providing a video image at a reduced resolution (typically 640×480 pixels). For example, an image sensor with 3200×2400 pixels would have only every fifth pixel read out as described in U.S. Pat. No. 6,342,921. This is often referred to as sub-sampling, or sometimes as thinned out mode or skipping mode. The disadvantage of sub-sampling the image by a factor of 5 is only 4% of the photodiodes are used. A sub-sampled image suffers from reduced photosensitivity and alias artifacts. If a sharp line focused on the image sensor is only on the un-sampled pixels, the line will not be reproduced in the video image. Other sub-sampling schemes are described in U.S. Pat. Nos. 5,668,597 and 5,828,406.

Prior art including U.S. Pat. No. 6,661,451 or U.S. patent application publication 2002/0135689 A1 attempts to resolve the problems of sub-sampling by summing pixels together. This prior art sums pixels together vertically not horizontally.

U.S. patent application publication 2001/0010554 A1 increases the frame rate by summing pixels together without sub-sampling. However, it requires a two field interlaced read out. It is more desirable to obtain a video image with progressive scan read out. Interlaced video acquires the two fields at different times. A moving object in the image will appear in different locations when each interlaced field is acquired.

Another disadvantage of the prior art is it only reduces the image resolution in the vertical direction. In the horizontal direction, the HCCD must still read out every pixel. Only reducing the image resolution through sub-sampling or other methods in the vertical direction does not increase the frame rate to 30 frames/second for very large (greater than 8 million pixels) image sensors.

U.S. patent application publication 2003/0067550 A1 reduces the image resolution vertically and horizontally for even faster image readout. However, this prior art requires a striped color filter pattern (a 3×1 color filter array), which is generally acknowledged to be inferior to the Bayer or 2×2 color filter array patterns.

In view of the deficiencies of the prior art, an invention is desired which is able to produce 30 frames/second video from a megapixel image sensor with a 2×2 color filter pattern while sampling more than half of the pixel array and reading out the video image progressive scan (non-interlaced).

### SUMMARY OF THE INVENTION

A method for reading out charge from an interlined CCD having a plurality of photo-sensing regions and a plurality of vertical shift registers, and each photosensitive region is mated respectively to a CCD of a vertical shift register and a color filter having a repeating pattern of two rows in which each row includes at least two colors that forms a plurality of 3 line sub-arrays sequentially numbered in the space domain; and the color filter spanning the photo-sensing regions, the method includes: (a) reading out lines 1 and 3 into the vertical shift register that keeps the colors separated; (b) summing the charge in lines 1 and 3; (c) transferring one row of the summed charge into a first horizontal charge-coupled device; (d) transferring alternate charges in the first horizontal charge-coupled device into a second horizontal charge-coupled device; (e) summing sets of two charges in the first horizontal charge-coupled device; (f) summing sets of two charges in the second horizontal charge-coupled device; and (g) reading out the charge in both the first and second horizontal shift register with a half-resolution clocking sequence.

### ADVANTAGEOUS EFFECT OF THE INVENTION

The present invention includes the advantage of producing 30 frames per second for video while sampling the pixel array in progressive scan readout at ⅓^{rd} resolution.

### BRIEF DESCRIPTION OF THE DRAWINGS

FIG. 1 is a prior art image sensor;

FIG. 2 is a typical color filter array for image sensors;

FIG. 3 is a diagram illustrating the flow of charge for reading out the first field of a two field interlaced image sensor of the present invention;

FIG. 4 is a diagram illustrating the flow of charge for reading out the second field of a two field interlaced image sensor of the present invention;

FIG. 5 is a detailed view of a pixel of the present invention including the VCCD;

FIG. 6 is a diagram illustrating the flow of charge for summing together two out of every three lines of the image sensor of the present invention;

FIG. 7 is a diagram illustrating the flow of summed charge in progressive scan fashion towards a HCCD;

FIG. 8 is a side view of the VCCD of FIG. 6 including the channel potential diagrams of the VCCD at various times steps of the clocking sequence for the charge summing operation as illustrated in FIG. 6;

FIG. 9 is the VCCD gate voltages at each time step of FIG. 8;

FIG. 10 is a side view of the VCCD, of FIG. 7 including the channel potential diagrams of the VCCD at various time steps of the clocking sequence for the transfer of summed charge towards the HCCD as illustrated in FIG. 7;

FIG. 11 is the VCCD gate voltages at each time step of FIG. 10;

FIG. 12 is a side view of a prior art HCCD including channel potential diagrams at various time steps of the clocking sequence for charge transfer in a pseudo-2-phase HCCD;

FIG. 13 is a timing diagram for FIG. 12;

FIG. 14 is a side view of a prior art HCCD including channel potential diagrams at various time steps of the clocking sequence for charge transfer in a pseudo-2-phase double speed HCCD;

FIG. 15 is a timing diagram for FIG. 14;

FIG. 16 is the image sensor of the present invention including the VCCDs containing summed charge packets and dual output HCCDs;

FIG. 17 is the image sensor of the present invention illustrating the transfer of summed charge packets into the first HCCD;

FIG. 18 is the image sensor of the present invention illustrating the transfer of half of the summed charge packets from the first HCCD into the second HCCD;

FIG. 19 is the image sensor of the present invention illustrating the transfer of summed charge packets in the second HCCD to align charge in the second HCCD with the first HCCD;

FIG. 20 is the image sensor of the present invention illustrating the transfer of charge in the first and second HCCD towards the output amplifiers without horizontal charge packet summing;

FIG. 21 is the image sensor of the present invention illustrating the process of the horizontal summing of charge packets of FIG. 20;

FIG. 22 is the image sensor of the present invention illustrating the result of the horizontal summing of charge packets of FIG. 20;

FIG. 23 is a detailed view of the HCCDs;

FIG. 24 is a timing diagram for full resolution readout of the HCCD of FIG. 23;

FIG. 25 is a timing diagram for horizontal summed readout of the HCCD of FIGS. 23 and 20;

FIG. 26 is a side view of cross section K-M of FIG. 23 including the channel potential diagrams illustrating the time steps sequence of charge transfer for full horizontal resolution readout;

FIG. 27 is a side view of cross section R-S of FIG. 23 including the channel potential diagrams illustrating the time steps sequence of charge transfer for full horizontal resolution readout;

FIG. 28 is a side view of cross section K-M of FIG. 23 including the channel potential diagrams illustrating the time steps sequence of charge transfer for half horizontal resolution double speed readout;

FIG. 29 is a side view of cross section R-S of FIG. 23 including the channel potential diagrams illustrating the time steps sequence of charge transfer for half horizontal resolution double speed readout; and

FIG. 30 is a camera illustrating a typical commercial embodiment for the image sensor of the present invention.

### DETAILED DESCRIPTION OF THE INVENTION

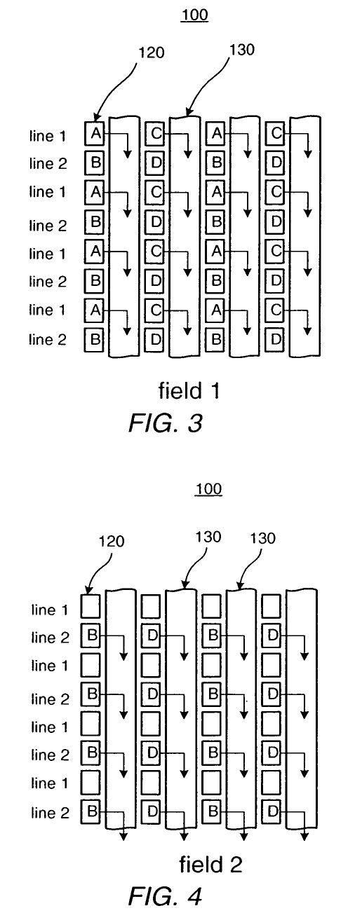

Referring to FIG. 3, there is shown the image sensor 100 of the present invention. For clarity, only a small portion of the pixel array of the image sensor 100 is shown. It consists of an array of photodiodes 120 with VCCDs 130 positioned in between columns of photodiodes 120. There are color filters repeated in a 2×2 array spanning across the entire photodiode array. The four color filters A, B, C, and D are of three or four unique colors. The colors typically are, but not limited to, A=red, B=and C=green, and D=blue. Other common color schemes utilize cyan, magenta, and yellow or even white filters.

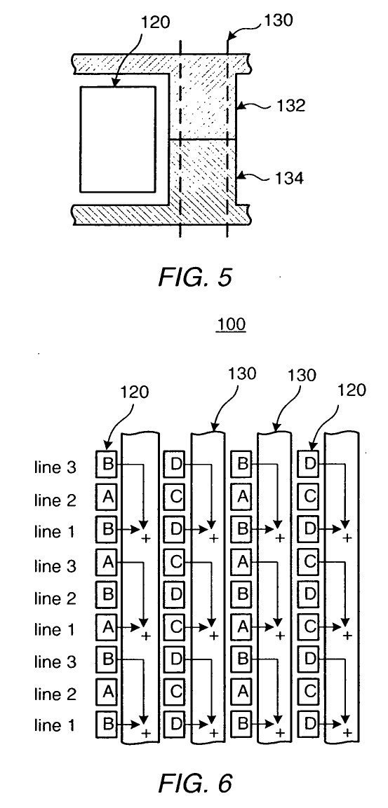

Referring briefly to FIG. 5, one pixel is shown. The VCCD 130 is of the interlaced 4-phase type with two control gate electrodes 132 and 134 per photodiode 120.

Referring back to FIG. 3, the full resolution read out of an image stored in the photodiodes 120 proceeds in the below-described manner for an interlaced image sensor 100. First the charge in field 1, consisting of all lines labeled as line 1, is transferred from the photodiodes 120 to the adjacent VCCD 130. The VCCD 130 will only receive charge from lines containing colors A and C. Once charge is in the VCCD 130, it is transferred in parallel towards a serial horizontal CCD, HCCD, (not shown) and then towards an output amplifier (not shown), as is well known in the art. Next in FIG. 4, after all signals from colors A and C have been transferred out of the VCCD 130, the remaining charge in the photodiodes 120 in line 2 is transferred into the VCCD 130. This is field 2 containing only colors B and D. Since the image is read out in two fields, an external shutter is used to block light and prevent further accumulation of signal in the second field while the first field is being read out.

When the sensor is installed in a digital camera and is to be used in video mode, the external shutter is held open and the image sensor 100 is operated continuously. Most applications define video as a frame rate of at least 10 frames/sec with 30 frames/sec being the most desired rate. Currently, image sensors are typically of such high resolution that full resolution image readout at 30 frames/sec is not possible at data rates less than 50 MHz and one or two output amplifiers. The solution of the present invention is to sum together pixels inside the image sensor to reduce the number of pixels down to a resolution allowing video rate imaging.

The case where frame rate is increased by reducing the vertical resolution by ⅓^{rd} is now discussed. Referring now to FIG. 6, this is the same image sensor 100 that was shown in FIG. 3 with a different read out sequence. The lines are labeled as line 1, line 2, and line 3. This labeling is repeated every three lines of the entire image sensor. The process of reading out charge from the photodiodes 120 begins in line 1 and line 3 where charge is transferred into the VCCD 130 and the VCCD 130 is clocked such that the two charge packets from lines 1 and 3 are summed together in the VCCD 130. Note that line 2 photodiodes are not transferred to the VCCD 130. They are never read out in video mode. Charge collected in the line 2 photodiodes spills out the vertical overflow drain.

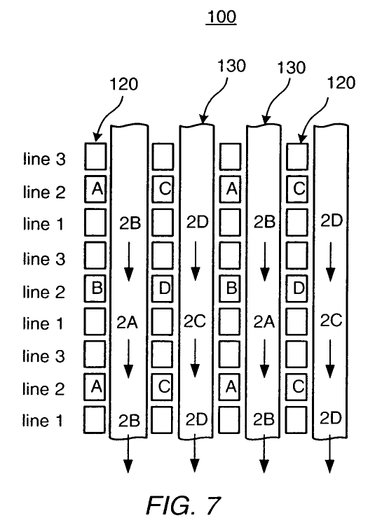

Now the image sensor 100 will be in the state shown in FIG. 7. Two rows containing colors have been added together. Each charge packet in the VCCD 130 contains the summed charge of two photodiodes 120 as indicated by the labels 2A, 2B, 2C and 2D. All photodiodes were read out simultaneously so that electronic shutter exposure control is possible in this video mode. When the image sensor 100 is in the state shown in FIG. 7, the summed charge packets may be read out of the VCCD 130 in a normal progressive scan sequence. Only one field needs to be read out and the VCCD 130 contains ⅓^{rd} the number of lines as the full resolution case shown in FIGS. 3 and 4. This speeds up the frame rate by a factor of 3.

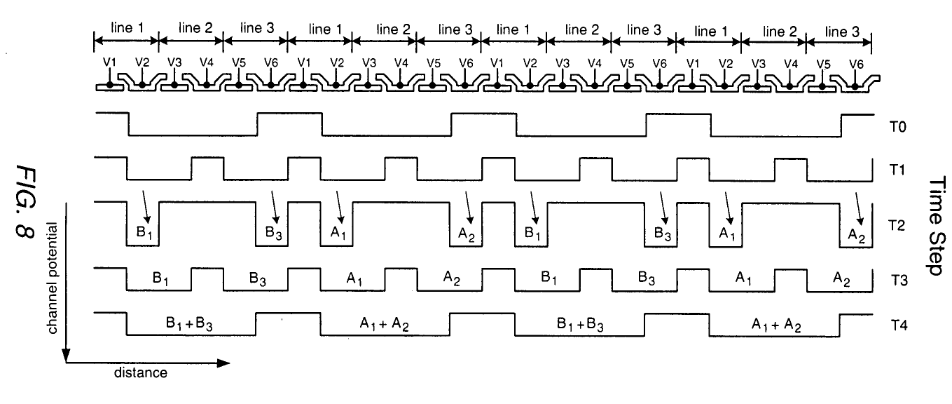

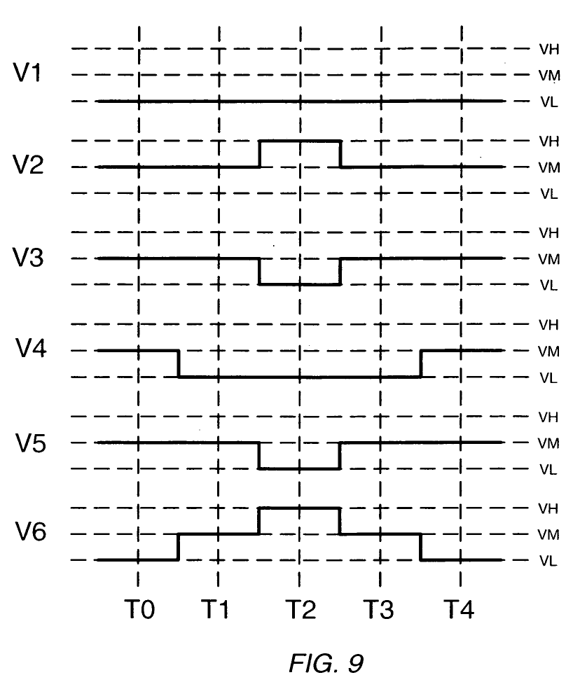

FIG. 8 shows the charge packet clocking details. FIG. 8 is a cross section down the center of the VCCD 130 of the column containing pixels of colors A and B. The labels A or B identify the color of the charge packet and the subscript numeral identifies from which line the charge packet originated. The labels T0 through T1 mark the time steps of the charge transfer clocking sequence. The gates V1 through V6 are clocked with the voltages shown in FIG. 9. The voltages VL is typically −7 V to −9 V and VM is in typically in the range of −2 V to +2 V. VH is the voltage level that turns on the transfer gate between the photodiodes and VCCD and is typically greater than +7 V. At time step T2 the control gates V2 and V6 are pulsed to their highest voltage to turn on the transfer gate between the photodiodes and VCCD. This causes charge transfer from only lines 1 and 3 photodiodes into the VCCD. Time steps T3 and T4 sum together charge packets of like colors in the VCCD.

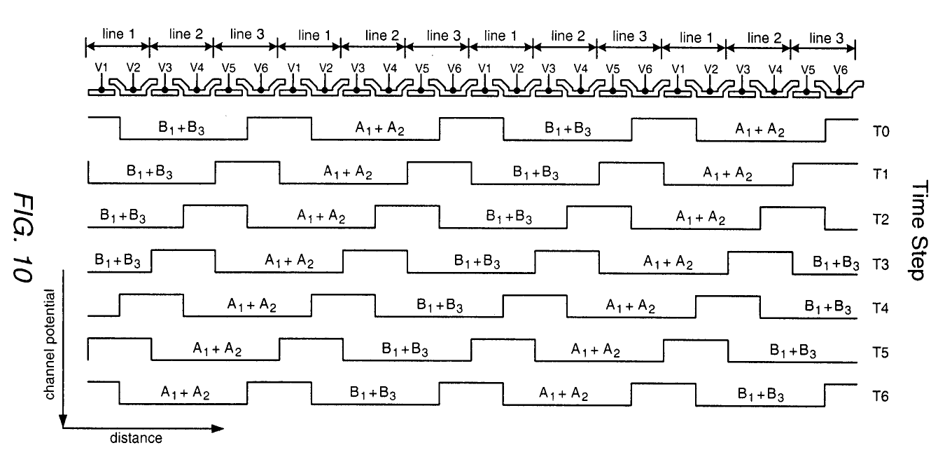

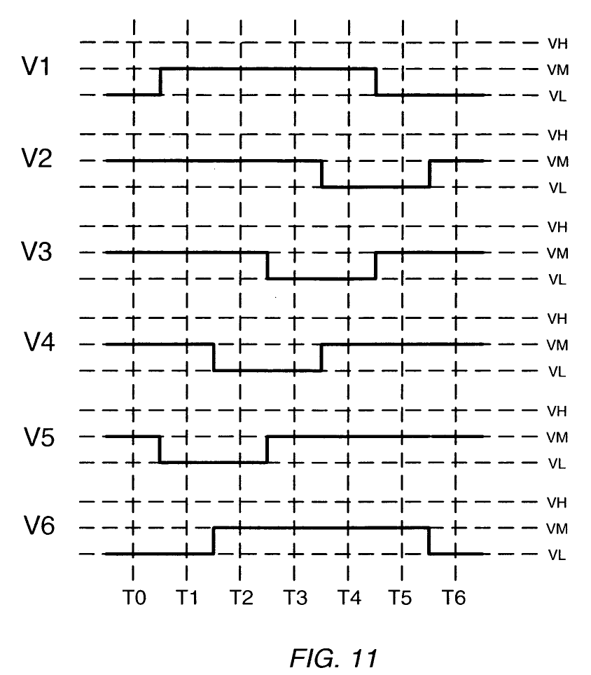

FIG. 10 shows the same cross section as FIG. 8 down the center of the VCCD 130 of the column containing pixels of colors A and B. FIG. 10 time step T0 is the result of the charge summing process shown in FIG. 8. FIG. 10 time steps T1 through T6 show the 6-phase clocking sequence to transfer one row of charge into the horizontal CCD. The gate control voltages V1 through V6 at each time step of FIG. 10 are shown in FIG. 11.

Thus far the present invention discloses how to sum together two lines of charge packets to increase the frame rate by a factor of three. Even if an image sensor with 2304 lines is reduced in resolution to 768 lines (XVGA resolution) by summing two line pairs it will still take longer than 1/30 sec to read out an image 3027×768 pixels. The solution to faster image read out is to also sum together charge packets in the HCCD to reduce the horizontal resolution by a ½.

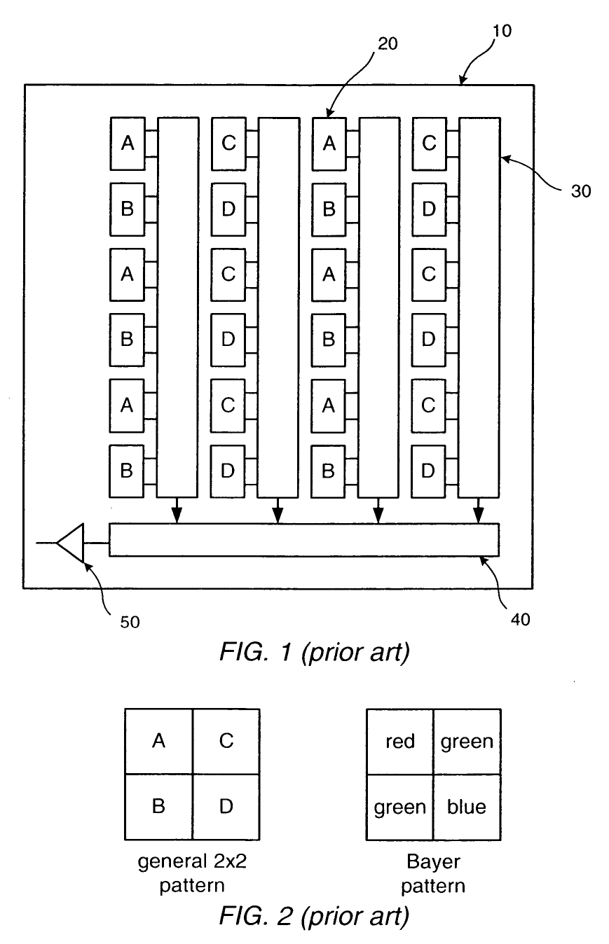

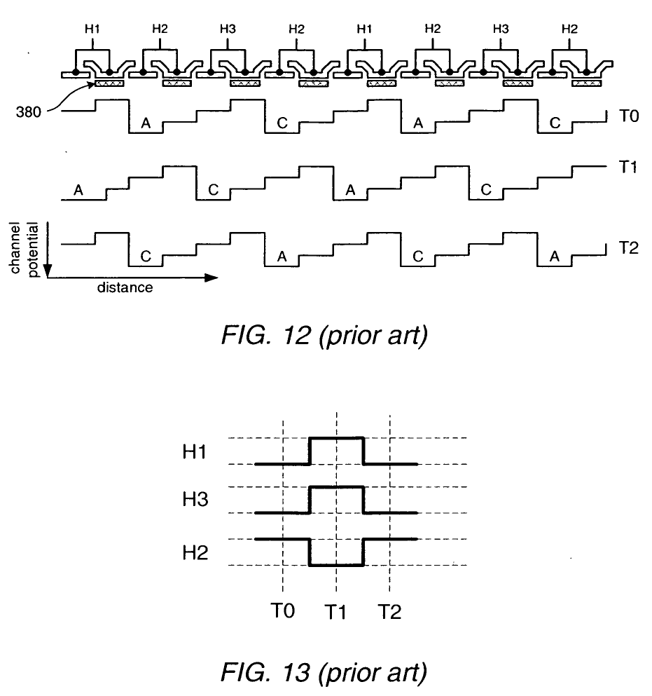

Referring to FIG. 12, there is shown a well-known prior art HCCD. It is a pseudo-two phase CCD employing four control gates per column. Each pair of two gates H1, H2 and H3 are wired together with a channel potential implant adjustment 380 under one of the two gates. The channel potential implant adjustment 380 controls the direction of charge transfer in the HCCD. Charge is transferred from the VCCD one line at a time under the H2 gates of the HCCD. FIG. 12 shows the presence of charge packets from the line containing colors A and C from FIG. 1. The charge packets are advanced serially one row through the HCCD at time steps T0, T1, and T2, by applying the clock signals of FIG. 13.

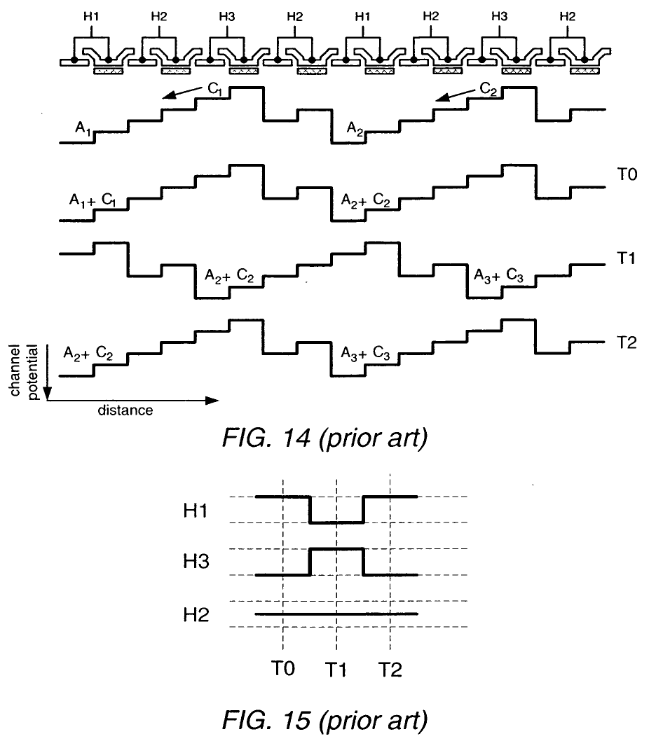

U.S. Pat. No. 6,462,779 provides a method of summing two pixels in the HCCD to reduce the total number of HCCD clock cycles in half. This is shown in FIG. 14. This method is designed for linear or area image sensors where all pixels are one color for monochrome image sensors. In a two dimensional array employing the 2×2 color pattern of FIG. 2, each line has more than one color. Thus, in FIG. 14 when a line containing colors A and C is transferred into the HCCD and clocked with the timing of FIG. 15, the colors A and C are added together. That destroys the color information in the image.

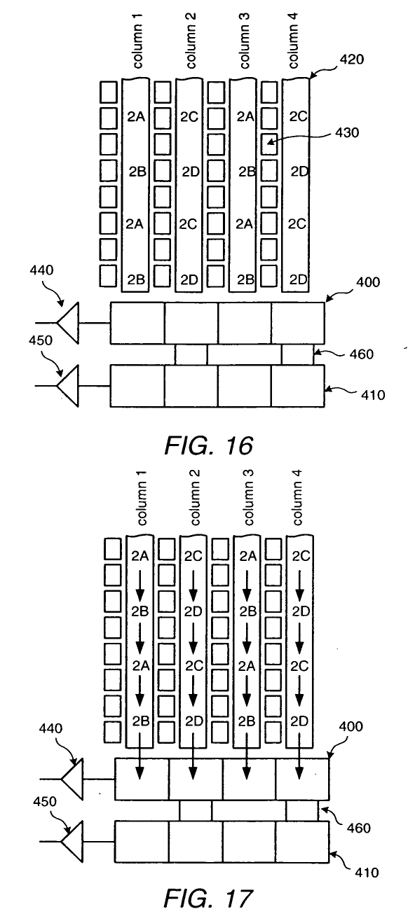

The present invention shown in FIG. 16 provides a method to prevent the mixing of colors when summing pixels in the HCCD. The invention consists of an array of photodiodes 430 covered by a 2×2 color filter pattern of four colors A, B, C, and D. Charge packets from the photodiodes 430 are transferred and summed vertically in the VCCD 420 using the two-line summing 3× vertical resolution reduction as described earlier. The result of the two line summing is depicted in FIG. 16. There is a first HCCD 400 and a second HCCD 410 located at the bottom of the pixel array. There is a transfer channel 460 every other column for the purpose of transferring half of the charge packets from the first HCCD 400 to the second HCCD 410. There is an output amplifier 440 and 450 at the end of each HCCD for converting the charge packets to a voltage for further processing.

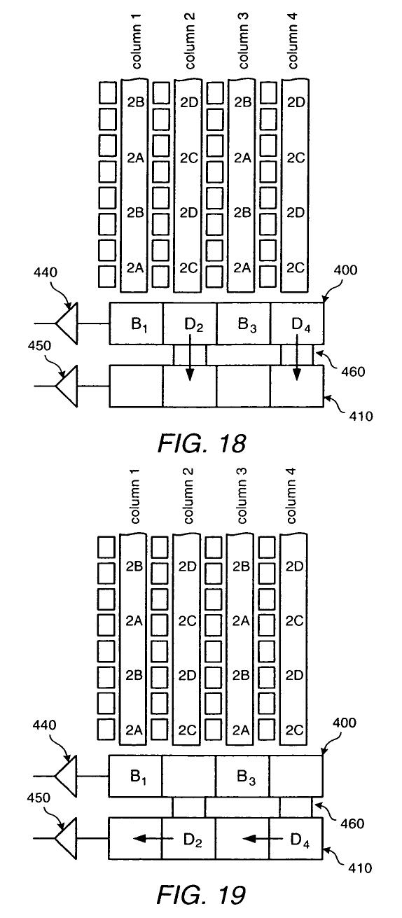

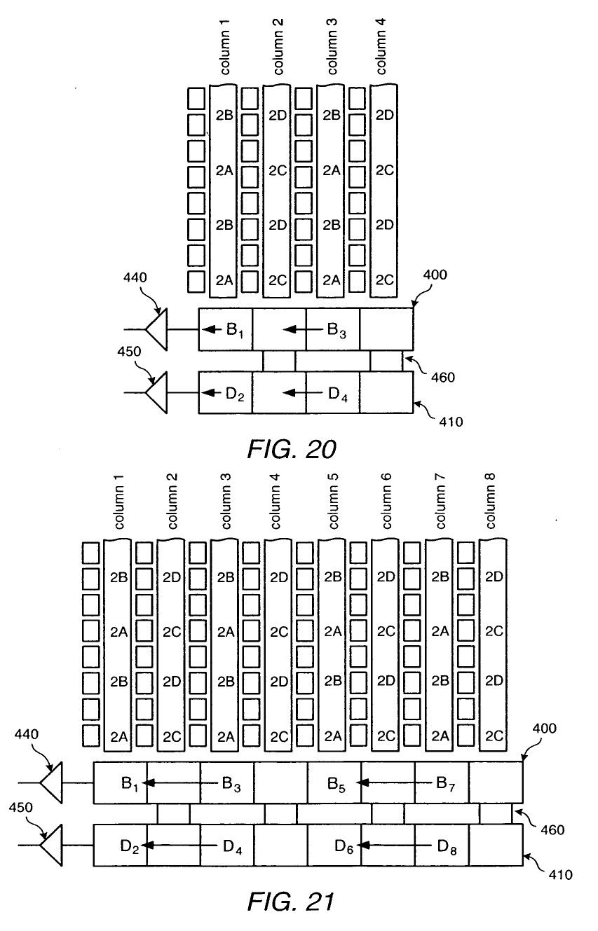

FIGS. 17 through 20 show the charge transfer sequence for reading out one line through the HCCD. First in FIG. 17, one line containing colors B and D is transferred into the first HCCD 400 as shown in FIG. 18. Charge packets in the HCCD are labeled with a letter corresponding to the color and a subscript corresponding to the column from which the charge packet originated. In FIG. 19, the charge packets from the even numbered columns only passed through the transfer gate 460 and into the second HCCD 410. In FIG. 20, the charge packets in the second HCCD 410 are advanced by one column to align them with the charge packets in the first HCCD 400. The number of clock cycles needed to read out each HCCD is equal to one half the number of columns in the HCCD. The addition of a second HCCD 410 reduces the read out time by half. Combined with the 3× vertical speed increase the total read out time of the entire array is now reduced by 6×. A 6× speed increase is still not sufficient for 30 frame/sec video operation. However, each HCCD now contains only one color type so a horizontal summing operation is possible with out mixing colors.

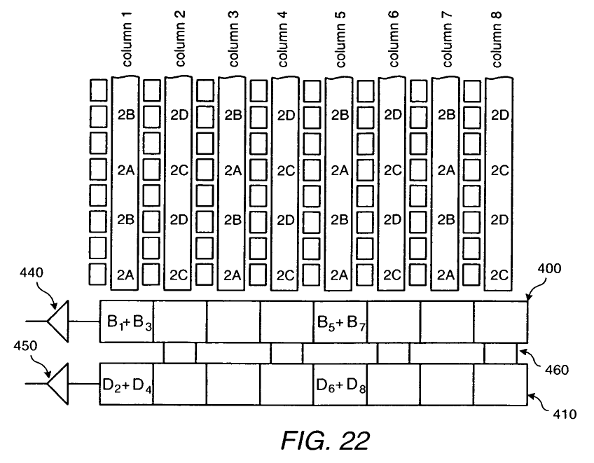

Two charge packets may be summed together horizontally in each HCCD 400 and 410 as shown in FIGS. 21 and 22. The summing is done without mixing charge packets of different colors. The two pixel summing reduces the number of charge packets to read out of each HCCD 400 and 410 by another factor of two. This two pixel summing is defined herein as a half-resolution clocking sequence. This HCCD design provides a total speed improvement of a factor of four. Combined with the 3× vertical resolution reduction line summing described earlier, this provides a twelve-fold increase in frame rate for a video mode. That is enough to allow image readout of a 1024×768 XVGA video image at a frame rate of 30 frames/second.

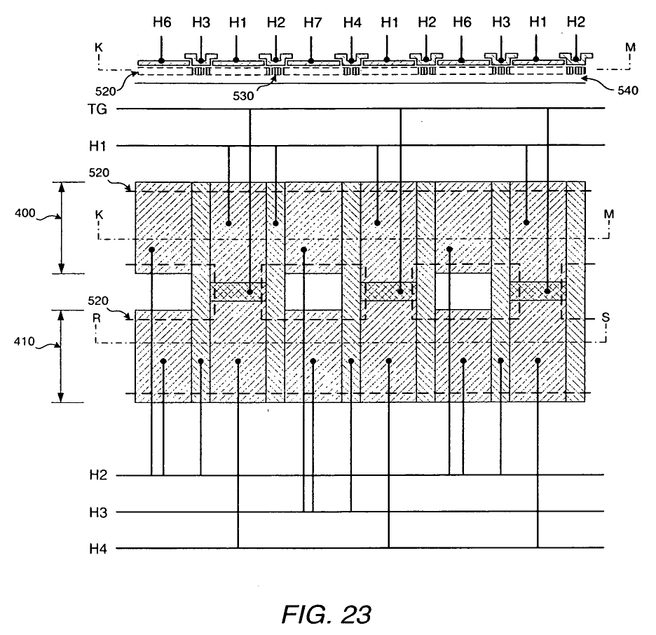

FIG. 23 shows the HCCD structure in greater detail. There is the first HCCD 400 and second HCCD 410 fabricated on top of an n-type buried channel CCD 520 in a p-type well or substrate 540. There are p-type channel potential adjustment barrier implants 530 to control the direction of charge transfer in the first and second HCCD. The top portion of FIG. 23 shows the side view cross section K-M through the first HCCD 400. There are four wires, which supply the control voltages to the HCCD gates H1 through H4. An additional wire TG controls the transfer gate between the two channels. The gate electrodes are typically, but not required to be, poly-silicon material of at least two levels. A third level of poly-silicon may be used for the transfer gate if the manufacturing process used does not allow the first or second levels of poly-silicon to be used. With careful use of implants in the buried channel of the transfer gate region and slightly modified gate voltages the transfer gate can be omitted entirely. The exact structure of the transfer gate is not important to the function of the invention.

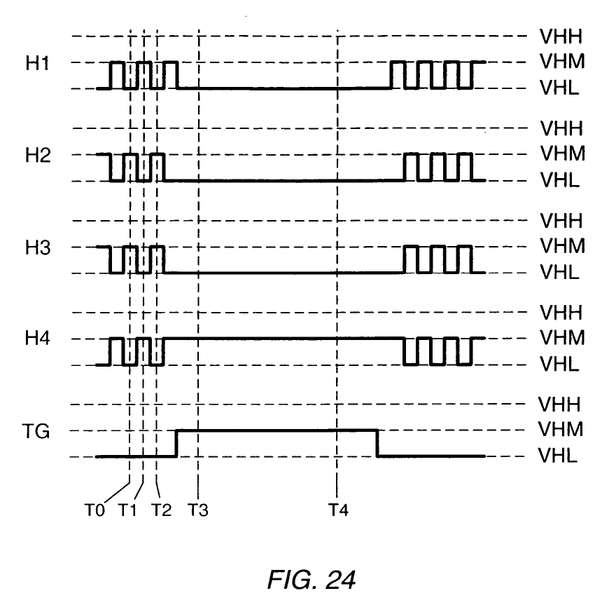

The clock voltages applied to the HCCD of FIG. 23 for full resolution read out are shown in FIG. 24. A typical voltage set for the HCCD would be VHH=+3 V, VHM=0 V, and VHL=−3 V. At Time T3 the transfer gate turns on while all of the gates in the first HCCD 400 are turned off (the VHL state). Charge packets in the columns aligned with the transfer gates TG flow into the first HCCD 400 across the transfer gate TG and then into the second HCCD 410. Charge packets in the other columns not aligned with the transfer gates TG remain in the first HCCD 400.

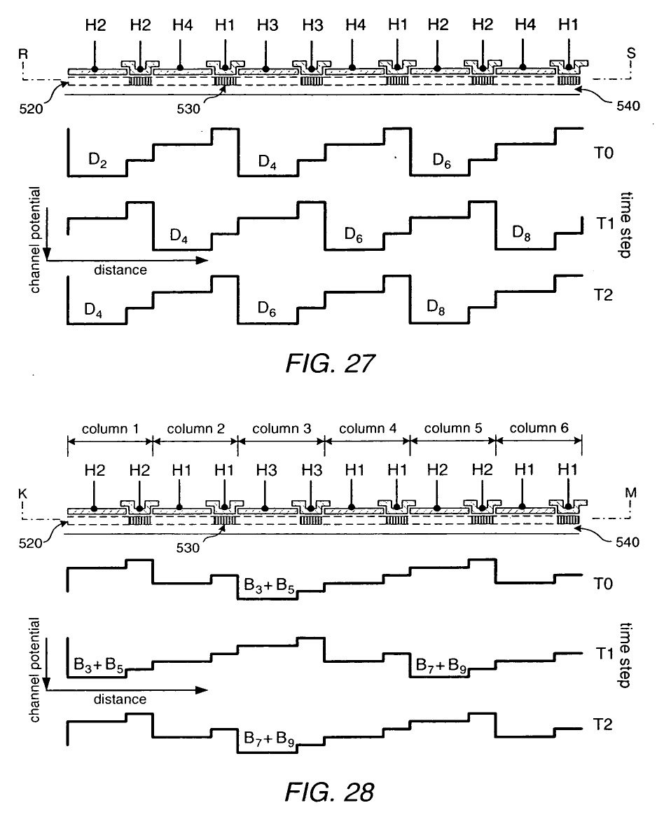

The following discusses the readout of the HCCD in full resolution mode for still photography. FIG. 26 shows the charge transfer sequence for the first HCCD 400 and FIG. 27 shows the charge transfer sequence for the second HCCD 410. A letter corresponding to the color of the charge packet, A, B, C, or D, identifies the charge packets. The subscript on the charge packet label corresponds to the column number of the charge packet. The clock voltages for each time step T0, T1, and T2 are shown in FIG. 24. The HCCD is clocked as a pseudo 2-phase CCD between two voltages VHM and VHL. The transfer gate TG is held in the off state (VHL) to prevent mixing of charge between the two HCCDs.

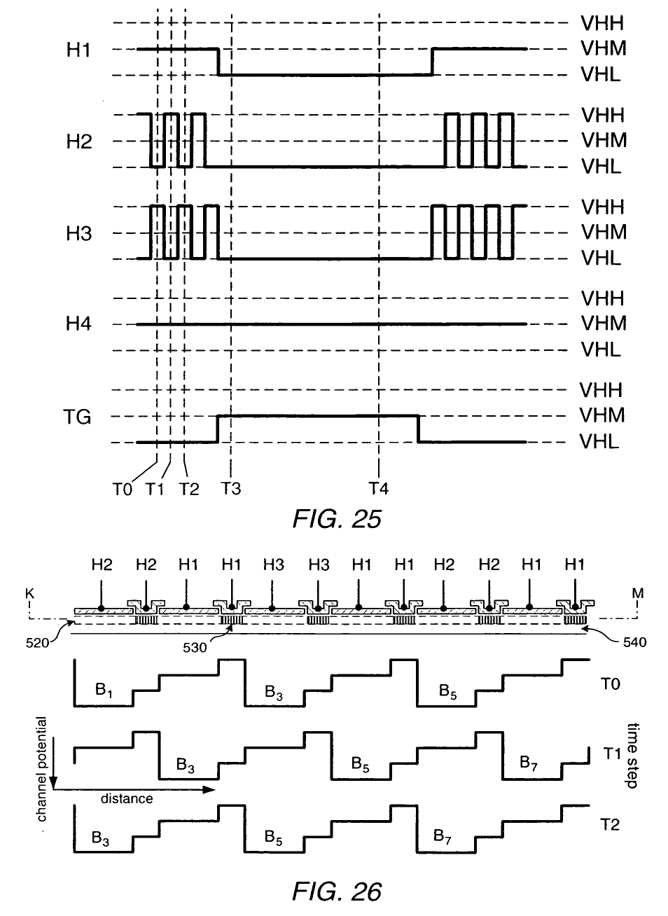

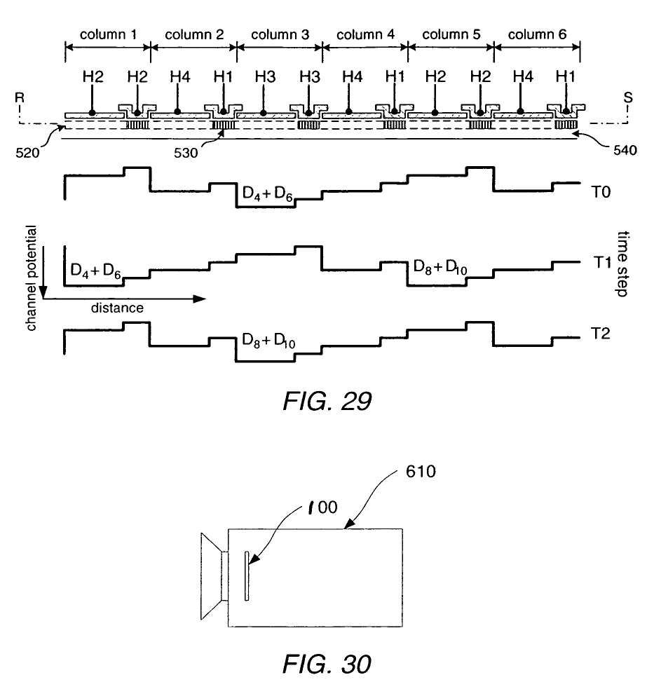

In video mode, two charge packets are summed together as shown in FIG. 28 for the first HCCD 400 and FIG. 29 for the second HCCD 410. Notice that the first HCCD 400 only contains charge packets from pixels of color B and the second HCCD 410 only contains charge packets from pixels of color D. FIG. 25 shows the gate voltage clocking sequence. Time steps T0, T1, and T2 of FIG. 25 corresponds to the time steps illustrated in FIGS. 28 and 29. Gates H1 and H4 are held at a constant value during the clocking sequence T0, T1, and T2. The gates on either side of H1 and H4 are clocked in a complimentary fashion. The charge packets move twice the distance for each clock cycle in this half-resolution clocking sequence when compared to the full resolution read out mode of FIGS. 26 and 27.

Due to the large number of photodiode charges being summed together there is the possibility of too much charge in the VCCD or HCCD causing blooming. The VCCD and HCCD can easily be overfilled. It is widely known a voltage applied to the image sensor substrate regulates the amount of charge in a vertical overflow drain type photodiode. This voltage is simply adjusted to reduce the photodiode charge capacity to a level to prevent overfilling the VCCD or HCCD. This is the exact same procedure normally used even without summing together pixels.

FIG. 30 shows an electronic camera 610 containing the image sensor 100 capable of video and high-resolution still photography as described earlier. In video mode 67 percent of all pixels are sampled.

The VCCD charge capacity is controlled by the amplitude of the VCCD gate clock voltages. Since the invention sums charges in the HCCD the VCCD does not have to contain full charge packets in order to produce a full signal at the output amplifiers. If the HCCD will sum together two charge packets then VCCD charge capacity can be reduced by a factor of two by lowering the amplitude of the VCCD clock voltages. The advantage of lowering the VCCD clock voltages, is reduced power consumption in video mode. The power consumption varies as the voltage squared. Thus a camera would increase the VCCD clock voltages if the camera is operating in still photography mode, and decrease the VCCD clock voltages if the camera is operating in video mode.

### Parts List

10 charge-coupled device (CCD) image sensor
20 photodiodes
30 vertical CCD (VCCD)
40 horizontal CCD (HCCD)
50 output amplifier
100 image sensor
120 photodiodes
130 vertical CCD (VCCD)
132 control gate electrode
134 control gate electrode
380 channel potential implant adjustment
400 first horizontal CCD (HCCD)
410 second horizontal CCD (HCCD)
420 vertical CCD (VCCD)
430 photodiodes
440 output amplifier
450 output amplifier
460 transfer channel/gate
520 n-type buried channel CCD
530 p-type channel potential adjustment barrier implants
540 p-type well or substrate
610 electronic camera

1. A method for reading out charge from an interlined CCD having a plurality of photo-sensing regions and a plurality of vertical shift registers, and each photosensitive region is mated respectively to a CCD of a vertical shift register and a color filter having a repeating pattern of two rows in which each row includes at least two colors that forms a plurality of 3 line sub-arrays sequentially numbered in the space domain; and the color filter spanning the photo-sensing regions, the method comprising:
(a) reading out lines 1 and 3 into the vertical shift register that keeps the colors separated;
(b) summing the charge in lines 1 and 3;
(c) transferring one row of the summed charge into a first horizontal charge-coupled device;
(d) transferring alternate charges in the first horizontal charge-coupled device into a second horizontal charge-coupled device;
(e) summing sets of two charges in the first horizontal charge-coupled device;
(f) summing sets of two charges in the second horizontal charge-coupled device; and
(g) reading out the charge in both the first and second horizontal shift register with a half-resolution clocking sequence.

2. The method as in claim 1 further comprising the steps of repeating steps (c) through (g) for reading out all of the summed charges.

3. A camera comprising:
(a) an interlined CCD having a plurality of photo-sensing regions and a plurality of vertical shift registers, and each photosensitive region is mated respectively to a CCD of a vertical shift register and a color filter having a repeating pattern of two rows in which each row includes at least two colors that forms a plurality of 3 line sub-arrays sequentially numbered in the space domain; and the color filter spanning the photo-sensing regions;
(b) a transfer device for reading out lines I and 3 into the vertical shift registers that keep the colors separated; wherein the vertical shift registers sum the charge in lines I and 3;
(c) a first horizontal charge-coupled device that receives one row of the summed charge; and
(d) a second horizontal charge-coupled device that receives alternate charges from the first horizontal charge-coupled device;
wherein the first horizontal charge-coupled device sums sets of two charges in the first horizontal charge-coupled device which summed charges are read out with a half-resolution clocking sequence; and wherein the second horizontal charge-coupled device sums sets of two charges in the second horizontal charge-coupled device which summed charges are read out with a half-resolution clocking sequence.

4. The camera as in claim 3, wherein all of the summed charges are read out.
